(19) United States
(12) Patent Application Publication
(10) Pub. No.: US 2007/0077337 A1
(43) Pub. Date: Apr. 5, 2007

(54) Process for the preparation of instant soup mix from indian dill (anethum sowa)

(76) Inventors: Narayan Rekha Mysore, Karnataka (IN); Attar Singh Chauhan, Karnataka (IN); Ramesh Yadav Avula, Karnataka (IN); Manisha Guha, Karnataka (IN); Shyam Ranesh Ramteke, Karnataka (IN)

Correspondence Address: EDWARDS & ANGELL, LLP, P.O. BOX 55874, BOSTON, MA, 02205, US

(21) Appl. No.: 10/584,664

(22) PCT Filed: Dec. 27, 2003
(86) PCT No.: PCT/IB03/06190

§ 371 Date: Sep. 6, 2006

(51) Int. Cl. A23B 4/03

(52) U.S. Cl. 426/443

(57) ABSTRACT

The present invention relates to a process for the preparation of instant soup mix from Indian dill (Anethum Sowa) and the soup mix has good anti-oxidant properties to the extent as shown by the values of phenol content mg/g 4.5 with reducing power of 870 U/g.

### FIELD OF THE INVENTION

The present invention relates to a process for the preparation of instant soup mix from Indian dill (Anethum sowa)

### BACKGROUND AND PRIOR ART

Soup mixes are convenient to prepare and are popular appetizers. Soups based on corn, chicken, mixed vegetables, palak and mushroom etc. are common in India and abroad. Apart from good storage stability of these products, the products with nutritional/therapeutic properties will be well received all over the world because of the increasing health consciousness amongst the population. Indian dill, locally known as ‘sowa’ in Northern India and ‘Sabsige’ in Southern India is a well-known leafy plant that can be classified under spices and condiments. It has good anti-oxidant properties as seen from the phenol content 1760 mg/g with a reducing power of 2531 U/g, by virtue of which the value added products based on ‘sabsige’ will find demand and hence, ready market. Further, thin soups with reduced viscosities indicate their ability of holding more quantities of solids thus enhancing its energy and nutrient density. By incorporating modified starches into soup mixes, the reduction in their pasting behavior can be achieved. The formulation of such healthy products involves the optimized drying of all the ingredients concerned and mixing in suitable proportions apart from modifying the starch by subjecting to physical treatments in order to yield thin paste viscosities.

There are no prior reports as such available in the literature for the preparation of “sabsige” based soup mix with reduced paste viscosities but a few prior reports are available with respect to soup powders/mixes.

Reference may be made to Rincon-AM, araujo-de-Vizcarrondo-C, Carillo-de-Padila-F, Martin-E (1984). Evaluation of the possible technological uses of some Dioscoreas tubers: name congo (Dioscorea bulbifera) and mapuey (Dioscorea trifida).archivos-Latinamericanos-de-Nutricion; 50(3) 286-290. Wherein, the rheological properties of yam meal were studied to evaluate the possible food uses. Absence of a viscosity peak and the high temperature stability of congo meal make it an ideal ingredient for instant soup mixes and that the meals of white and purple manpuey are suitable for sauce thickener.

The main draw back of this invention is that the product/meal obtained from fresh diacorea tubers of three different varieties were studied for their properties. Diascorea sp. contain toxic alkaloids, which have to be removed by certain treatments before using in food products. As the meal is not cooked/heat treated before use, the digestibility of this tuber starch will be poor on consumption compared to physically treated starches. Reference may be made to Unilever NV 1973. Method for producing a pea soup mixture. Netherlands-Patent-Application (7211214). Wherein, the production of soup mix is prepared from pea flakes made with cooked green split peas, hydrogenated oil and raw potato starch.

The main drawback of this invention is that the product development involved the formation of paste by mixing the ingredients and drying the paste into a thin film to form flakes. The flakes are further agglomerated with pea flour, corn syrup solids etc. followed by drying.

Reference may be made to Spice & Flavour Services Ltd. (1971). Dry soup mixes. British patent (1254562). Wherein, the soup mixes suitable for vending machines were prepared. Unmodified starch was used as a thickening agent and the ingredients were coated with a fat containing an emulsifying agent.

The main draw back of this process is usage of unmodified starch as thickening agents and no Indian Dill is used in the mix which has anti-oxidant property.

Reference may be made to Govindan, T. K (1970) Freeze drying of fishery products: preparation of instant fish soup mixes and their preservation by freeze drying. Research and Industry.-C.S.I.R., India 15(3) 162-163. Wherein, a process for extruded noodles from cooked fish, minced with onion, ‘vanaspati’, salt etc. with monosodium glutamate and freeze dried to be used as soup mix. The product is reconstituted with boiling water.

The main drawback in this process is that fish based soup mix is prepared by freeze-drying method which is an expensive technique. The product will be in the form of a noodle till reconstitution and hence an extruder operation is also involved.

Reference may be made to Anon (1971) New: air-dried mushrooms. Agricultural Research (Washington); 19 (7)6. Wherein, development of dried mushroom by hot air drying at low temperature followed by high temperature was described. The dried mushroom was comparable with that of freeze-dried mushroom in flavor.

The main draw back of this process is that it is a combination of both high and low temperature drying for flavour retention of mushrooms. The process relates the use of such dried mushrooms in soup mixes.

Reference may be made to Essink-GK (1994) Potato based texturisers for dry and liquid foods. Food Marketing & Technology; 8(3)12-14. Wherein, the properties of potato starch as an ingredient in tomato sauce, paste, powdered tomato etc. were discussed.

The desired texture in sauces could be achieved by using appropriate starch or any other non-hydrocolloid functional ingredients.

The Main drawback of the above process is that the effective application or suitability of starch or other functional non-hydrocolloids was studied with reference to tomato sauce.

Reference may be made to McComber-DR; Osman-EM (1991) Use of concentrated and pure Pontiac potato starch. U.S. Pat. No. 4,981,710. Wherein, non-cross linked Pontiac potato. starch was used as starch source in an edible food product mix. Since it is resistant to thinning, Pontiac starch is suggested for soups as a thickening agent.

The Main drawback of the above process is that the Pontiac starch is suggested in food product mixes in place of other chemically modified thickening agents owing to its abnormal behavior of resistance to thinning.

Reference may be made to Ibanoglu-S (1999). Functional properties of spray dried tarhana. Drying Technology; 17(1/2), 327-333. Wherein, the soups made with traditional tarhana (fermented yogurt-wheat flour mixture) and spray dried tarhana were compared. The low sensory scores of soup based on spray-dried tarhana was due to the chemical treatment given to reduce the slurry viscosity.

The main drawback of above process is that the soups are prepared from chemically modified (acid hydrolysed) starch source. Though the slurry viscosity is reduced, the product showed very low sensory score.

Reference may be made to Ibanoglu-S, Ibanoglu-E, Ainsworth-P (1998) Effect of dilute acid hydrolysis on the cooked viscosity of tarhana, a traditional Turkish cereal soup. International Journal of Food Sci. & Nutrition; 49 (6), 463-466. Wherein, it was shown that during acid hydrolysis of tarhana to obtain a low viscosity tarhana with high solids, concentration of acid had the most pronounced effect on the viscosity though interaction of time with temperature were also significant. A regression equation was developed to obtain tarhana soups of desired viscosity.

The main draw back of the above process is that the finished product is based on a chemically modified starch source. Though the viscosity was reduced to a desired level, acid modification resulted in low sensory scores. Reference may be made to Gaines-C S, Kassuba-A, Finney-P L (1995) A soup model study comparing flour peak viscosity during heating and viscosity of flour gels during reheating. Cereal Chemistry; 72(3), 233-236. A visco-graph was used to study a model system based on apparent viscosity of commercial canned soups. Unless flours were produced from highly field sprouted wheat, there was no relation between hot paste viscosity attained during first heating and viscosity of the same pastes that were allowed to gel before being stored and reheated to serving temperature. Prediction of viscosity of flour-thickened soups at serving temperature may be better accomplished using direct measurement of alpha amylase activity or determination of reheated gel viscosity rather than viscograph hot paste peak viscosity.

The main draw back of the above work is that the studies were confined to wheat flour based commercial canned soups hence alpha amylase activity determination may not be a serving temperature were reported.

Reference may be made to Sopade-R A, KassuM-A L, Adamu-D J M (1993) Rheological characterization of some Nigerian traditional soups. International Journal of food Sci. & Technol. 28(6), 647-653. Wherein, the rheological properties of soups in the temperature range 10-70° C. were investigated and found that the decrease in apparent viscosity of soups with speed indicated pseudo-plastic behaviour. The use of sun dried materials, as ingredients did not alter the pseudoplastic behaviour. The main draw back of the above work is that the studies were confined to the behaviour of soups and the changes in their plasticity behaviour on using sun dried materials, mainly the okra.

Reference may be made to Ohira-T, Mijano-R, Yoshida-R (1981) Smoked starch. UK Patent application 2050798A. Wherein, the retention of viscosity and gel forming ability on heating and subsequent cooling of starches were improved by smoking at a given temperature for 2 to for 3 min. and by pH modification. Such modified starches were found useful for dairy, confectionery, soups and meat and fish products.

The main draw back of the above work is that the studies were conducted by chemical modification, moisture and pH adjustment of starches.

### OBJECT OF THE INVENTION

The main objective of the present invention is to provide a process for the preparation of Instant soup mix from Indian dill.

In another objective of the present invention is to provide a process for the preparation of Indian dill powder.

Yet in another objective of the present invention is to provide a process for the preparation of modified potato starch with reduced paste viscosity.

Still, yet in another objective of the present invention is to provide a process for preparation of onion powder for the use in the soup mix.

Still in another objective of the present invention is to reduce the moisture of content of soup mix by hot air drying.

The novelty of the present invention is that the soup mix is an instant, low viscous product with good anti-oxidant properties. It is a free flowing, convenience product prepared by virtue of this invention using sabsige, modified potato flour, maltodextrin and other ingredients. The process also includes mixing of dry ingredients to maintain low moisture followed by finish drying to bring down the moisture of soup mix further to 5%, addition of Tertiary Butyl Hydro Quinone (TBHQ) at 200 ppm level on fat weight basis to the soup mix. The product is free flowing with a moisture content: 3-5%, Critical Moisture Content 11%, Fat 9.5%, Free Fatty Acids mg/g: 3.36, Peroxide Value/g: Nil, Hunter Color values as L,A,B, L: 73.0, A:−4.137, B: 16.13. Total plate counts: 18750/g, and Yeast and Molds: Nil

As the Indian dill is commonly considered as spices and condiments, people think it is not for making soup. Contrary to this belief the applicants used the Indian dill for preparing soup and found very much effective to soup lovers.

### SUMMARY OF THE INVENTION

Indian Dill or ‘Sabsige’ based dry soup mix containing modified starch has low paste viscosities thereby help in holding more solids. It is thus a nutrient and energy dense product with anti oxidant property. Fresh leaves have good anti-oxidant properties as seen from the phenol content 1760 mg/g, by virtue of which the value added products based on ‘sabsige’ will find demand. Soup mix formulation having ratio of different ingredients in the range—skim milk powder:corn flour:potato flour:wheat flour:malto dextrin:fat:dill powder:salt:sugar:onion:pepper, 20:15:11.75:12.5:12.5:7.5:5:6:2.5:1.75 then finish dried and packed in metallasied polyester/polyethylene laminate pouches (200 gauge), has a shelf life up to 8 months at room temperature with 65% relative humidity. The formulation also showed antioxidant property to the extent as shown by the values of phenol content of 4.5 mg/g with a reducing Power of the source (soup mix) 870 U/g.

### DETAILED DESCRIPTION OF THE INVENTION

Accordingly, the present invention provides a process for the preparation of instant soup mix from Indian dill (Anethum sowa), which comprising the steps:
i. cutting the cleaned Indian dill leaves into shreds of 4-5 cm long;
ii. soaking the shreds of step (i) in a solution containing 0.5 to 1.0% sodium bi carbonate for a period of 20 to 40 minutes;
iii. drying the soaked shreds of step (ii) using hot air at a temperature in the range of 40°-50° C.;
iv. powdering the dried shreds of step (iii) and passing through sieve with a pore size of about 400 to 600 μm.
v. powdering the drum dried, cabinet dried and sun dried potato cubes, and dried onion shreds and passing through sieve with a pore size of about 500 μm;
vi. mixing skim milk powder:Corn flour:Potato flour:wheat flour:malto dextrin:fat:dill powder:salt:sugar:onion:pepper with a ratio in the range of 10-20:12-15:10-12:10-14:10-14:3-8:3-6:3-5:3-7:2-4:1-2.5 (w/w) respectively to obtain soup mix, and
vii. obtaining the instant soup mixture by drying the soup mix of step (vi) till the moisture content of the said becomes 3 to 5%.
viii. packing, the soup mixture of step (vii) in metallised polyester/polyethylene laminate pouches (200 gauge), has a shelf life up to 8 months in 65% relative humidity at RT.
ix. Reconstituting the soup mix in cold water (soup mix: water, 1:10-12), stirred and brought to boil has an excellent color, taste, flavor and consistency and over all quality.

In an embodiment of the present invention, the fresh, firm, uninfested Dill leaves may be washed trimmed and they are cut into portions of 4-5 cm length.

In another embodiment of the present invention, the cut Indian Dill leaves may be soaked in solution containing Sodium bi carbonate (leaf:Solution 1:2) for 20 minutes at RT (27-30° C.) followed by draining.

Yet, in another embodiment of the present invention, the drained shreds may be spread on aluminum trays, (load, 3 kg/sqm), surface dried in a cabinet drier at 45° C. for a period of 4-5 hrs.

Still in another object of the present invention the drum drying of potato is performed by following steps:
i. dicing the potatoes into cubes;
ii. cooking potatoes of step (a) at 70 to 75° C. in an autoclave for about 15 to 20 minutes followed by cooling at 12 to 17° C. for about 15 to 20 minutes;
iii. cooking the cooled potatoes of step (ii) at a temperature in the range of 75 to 85° C. for about 15 to 20 minutes;
iv. mashing the cooked potatoes of step (iii) in a mixture;
v. adding potassium metabisulphite in the range of 1500 to 2500 mg/kg, whey protein concentrate in the range of 0.02% to 0.09% and monosodium glutamate in the range of 0.05 to 0.1% to the potato mash, and
vi. drying the potato mash of step (v) and ground into powder followed by passing through a sieve with a pore size in the range of 400 to 600 μm to obtain the potato flour.

In another embodiment of the present invention cabinet drying of potato is performed by following steps:
i. dicing the potatoes into cubes;
ii. autoclaving the potatoes of step (i) for a period of about 3 to 8 minutes to inactivate the enzyme followed by cooling the same;
iii. adding potassium metabisulphite to the potatoes of step (ii) in the range of 1500 to 2500 mg/kg for a period of 10 to 30 minutes;
iv. drying the cooled potato of step (iii) at a temperature in the range of 60-70° C. for about 6 to 8 hours, and
v. grinding the dried potato of step (iv) into powder followed by passing through a sieve with a pore size in the range of 400 to 600 μm to obtain the potato flour.

Still in another embodiment of the present invention the drying and grinding of onion is performed by following steps:
i. slicing the peeled onion;
ii. drying the sliced onion of step (i) in hot air at a temperature in the range of 55 to 65° C. to obtain the dehydrated onion shreds, and
iii. grinding the dehydrated onion shreds of step (ii) and passing through a sieve with a pore size in the range of 400 to 600 μm to obtain the onion powder.

Still yet, in another embodiment of the present invention, the dried leaves may be powdered in a hammer mill of 500 μm sieve and packed in suitable polyethylene pouches and kept in air tight containers and stored at 12±1° C. for further use.

Still, in another embodiment of the present invention, the potato cubes may be dried after pretreatments in a mechanical drier and powdered in a hammer mill of 500 μm sieve. The above potato flour has a peak viscosity of 1636 cp, hot Paste viscosity of 1162 cp and cold paste viscosity of 1440 cp. The powder was packed in polyethylene pouches, kept in air tight containers and stored at 12±1° C. for further use.

Yet, in another embodiment of the present invention, the fresh pink onions were cut for topping and tailing, peeled and shredded using a slicer. Slices were then dried in a hot air drier at 65° C. for 4 hrs to get dehydrated onion shreds. Dried shreds powdered in a hammer mill of 500 μm sieve and packed in suitable polyethelyne pouches and kept in air tight containers and stored at 12±1° C. for further use.

Yet, in another embodiment of the present invention the soup mix was formulated by using ingredients such as Indian dill powder, wheat flour, corn flour, modified potato flour, skim milk powder, hydrogenated vegetable oil, salt, sugar, along with onion powder, pepper powder and anti oxidant.

The process of the present invention involves following steps
i) Cutting the cleaned Indian dill leaves into portions of 4-5 cm long using stainless steel knives.
ii) Soaking the shreds in a solution containing 0.5-1.0% sodium bi carbonate (Slices: Solution, 1:2) at RT (27-30° C.) for 20-40 minutes.
iii) The soaked leaves are drained and spread on to aluminum trays at the rate of 3-4 kg/sq m, and dried at 40°-50° C. in a hot air drier.
iv) The dried leaves were powdered in a hammer mill of 500 μm sieve and the powder.
v) The Drum dried, Cabinet dried and sun dried potato cubes, and dried onion shreds were powdered in a hammer mill of 500 μm sieve and the powder were prepared for use in the soup mix formulation.
vi) Soup mix formulation having ratio of different ingredients in the range—Skim milk powder:Corn flour:Potato flour:wheat flour:Malto dextrin:Fat:Dill powder:Salt:Sugar:Onion:Pepper, 10-20:12-15:10-12:10-14:10-14:3-8:3-6:3-5:3-7:2-4:1-2.5 (w/w).
vii) The peak viscosity, hot paste viscosity and cold paste viscosity of soup mix using drum dried potato flour in the above formulation were 127, 107 and 186 cps respectively.
viii) The peak viscosity, hot paste viscosity and cold paste viscosity of soup mix using cabinet dried potato flour in the above formulation were 145, 126 and 288 cps respectively.
ix) The peak viscosity, hot paste viscosity and cold paste viscosity of soup mix using Native potato flour in the above formulation were 182, 167 and 291 cps respectively.
x) The peak viscosity, hot paste viscosity and cold paste viscosity of soup mix using cabinet dried potato flour in place of corn flour and wheat flour in the above formulation were 133, 130 and 208 cps respectively.
xi) Soup mix made from modified potato flours show optimum pasting behavior for the formulation of soup when compared to native flour.
xii) The instant Indian dill soup mix based on the above formulation when finish dried to a moisture content of 3.5-4.5%, then packed in Metallsied Polyester/polyethylene laminate pouches (200 gauge), has a shelf life up to 8 months in 65% Relative Humidity at RT.
xiii) The soup mix when reconstituted in cold water (soup mix: water, 1:10-12), stirred and brought to boil has an excellent color, taste, flavor and consistency and over all quality.

### EXAMPLES

### Example 1

2.35 kg of fresh Indian dill were cut to separate the roots, and then the tender leaf and stalk portion were manually separated from the firm mature ones. Prepared material was washed thoroughly with tap water, cut into portions of 4-5 cm long using stainless steel knives. Shreds were soaked in a solution containing 0.5% sodium bi carbonate (Slices: Solution, 1:2) at RT for 20 minutes. The soaked leaves were drained and spread on to aluminum trays at the rate of 3 kg/sq m, and dried at 40° C. in a hot air drier to reduce the weight of the material to 150 g. The dried leaves were powdered in a hammer mill of 500 μm sieve and the powder (145 g) was used for the formulation of soup mix.

20 kg Fresh potatoes were washed and peeled using abrasive peeler followed by trimming with stainless steel peeler. The peeled potatoes (17.75 kg) were kept under water till they were fed into dicing machine provided with 1 cm cubic blade. The potatoes were diced into cubes. The diced cubes (17.75) were taken on perforated aluminum trays and cooked at 70-75° C. in an autoclave for 20 minutes, followed by cooling at 15° C. for 20 minutes. The cooled material was cooked again at 85° C. for 20 minutes followed by mashing in sigma mixer. 2000 ppm potassium metabisulphite, 0.05% whey protein concentrate and 0.05% monosodium glutamate were added to the mash. The potato mash was roller dried at 6 bar steam pressure and at a drum speed of 4 rpm. The dried flakes (3.7 kg) were collected and ground into powder through a hammer mill of 500 μm sieve. The drum dried potato flour (3.65 kg) prepared as above has a Peak Viscosity of 328 cp, Hot Paste Viscosity of 253 cp and Cold Paste Viscosity of 399 cp.

The fresh pink onions (9 kg) were cut for topping and tailing; they were peeled and sliced using a slicer. Slices (8 kg) were then dried in a hot air drier at 65° C. for 4 hrs to get dehydrated onion shreds. Dried slices (0.800 kg) were powdered in a hammer mill of 500 μm sieve. The powder (kg) was used in the formulation. The other ingredients used for the soup mix such as skimmed milk powder, salt, sugar, hydrogenated fat, wheat flour, corn flour, pepper powder, malto dextrin were procured from the market. Soup mix formulation had the following ratio of different ingredients, Skim milk powder Corn flour:Potato flour:wheat flour:Malto dextrin:Fat:Dill powder:Salt:Sugar:Onion:Pepper, 20:15:11.75:12.5:12.5:7.5:5:6:2.5:1.75. Tertiary Butyl Hydro Quinone (TBHQ) to an extent of 200 ppm on the weight of fat was incorporated. The product was finish dried in hot air drier to obtain a product with moisture content: 3.6%. The peak viscosity, hot paste viscosity and cold paste viscosity of soup mix were 127, 107 and 186 cps respectively.

### Example 2

Indian dill powder and onion powder as described in example 1 were used in the following example.

13.25 kg Fresh potatoes were washed and peeled using abrasive peeler followed by trimming with stainless steel peeler. The peeled potatoes (11.26 kg) were kept under water till they were fed into dicing machine provided with 1 cm cubic blade. The potatoes were diced into cubes. The diced cubes (11.26) were taken on perforated aluminum trays and blanched in an autoclave for a period of 4 minutes to inactivate the enzymes. After cooling, the pieces were soaked in 2000 ppm KMS solution for a period of 20 minutes at RT. The pieces were drained and dried in a mechanical drier at 65±2° C. for 6-8 hrs. The dried cubes (2.39 kg) were powdered in a hammer mill of 500 μm sieve. The potato flour (2.28 kg) prepared as above has a Peak Viscosity of 363 cp, Hot Paste Viscosity of 360 cp and Cold Paste Viscosity of 518 cp.

The other ingredients used for the soup mix such as skimmed milk powder, salt, sugar, hydrogenated fat, wheat flour, corn flour, pepper powder, malto dextrin were procured from the market. Soup mix formulation had the following ratio of different ingredients Skim milk powder:Corn flour:Potato flour:wheat flour:Malto dextrin:Fat:Dill powder:Salt:Sugar:Onion:Pepper, 20:15:11.75:12.5:12.5:7.5:5:6:2.5:1.75. Tertiary Butyl Hydro Quinone (TBHQ) to an extent of 200 ppm on the weight of fat was incorporated. The product was finish dried in hot air drier to obtain a product with a moisture content: 3.6%, critical moisture content 11%, fat 9.5%, free fatty acids 0.15 mg/g: 3.36, peroxide value/g: nil, hunter color values as L, a, b, L: 73.0, a: −4.137, b: 16.13. total plate counts: 18750/g, and yeast and molds: Nil, coliforms: Nil. The peak viscosity, hot paste viscosity and cold paste viscosity of soup mix were 145, 126 and 228 cps respectively. Its anti-oxidant value in terms of phenol content mg/g 4.5 with reducing Power of the source U/g (soup mix) 870.

### Example 3

Indian dill powder and onion powder as described in example 1 were used in the following example. The Native potato flour was used in the formulation.

The other ingredients used for the soup mix such as skimmed milk powder, salt, sugar, hydrogenated fat, wheat flour, corn flour, pepper powder, malto dextrin were procured from the market. Soup mix formulation had the following ratio of different ingredients Skim milk powder:Corn flour:Potato flour:wheat flour:Malto dextrin:Fat:Dill powder:Salt:Sugar:Onion:Pepper, 20:15:11.75:12.5:12.5:7.5:5:6:2.5:1.75. Tertiary Butyl Hydro Quinone (TBHQ) to an extent of 200 ppm on the weight of fat was incorporated. The product was finish dried in hot air drier to obtain a product with moisture content: 3.6%. The peak viscosity, hot paste viscosity and cold paste viscosity of soup mix were 182, 167 and 291 cps respectively.

### Example 4

Indian dill powder and onion powder as described in example 1 and potato flour as described in example 2 were used. The other ingredients used for the soup mix such as skimmed milk powder, salt, sugar, hydrogenated fat, wheat flour, corn flour, pepper powder, malto dextrin were procured from the market. Soup mix formulation had the following ratio of different ingredients Skim milk powder:Potato flour:Malto dextrin:Fat:Dill powder:Salt:Sugar:Onion:Pepper, 20:39.5:12.5:7.5:5:6:2.5:1.75. Tertiary Butyl Hydro Quinone (TBHQ) to an extent of 200 ppm on the weight of fat was incorporated. The product was finish dried in hot air drier to obtain a product with moisture content: 3.6%. The peak viscosity, hot paste viscosity and cold paste viscosity of soup mix were 133, 130 and 208 cps respectively.

Soup mix formulation was made with ingredients described as above excepting the modified potato starch. Native potato flour with Peak viscosity of 634 cp, hot paste viscosity of 604 cp and cold paste viscosity of 662 cp was used in the formulation. The soup mix showed Peak viscosity of 182 cp, hot paste viscosity of 167 cp and cold paste viscosity of 291 cp.

The soups prepared as per the examples and offered to 100 soup lovers. Out of 100 tasted the soup, 70% said the soup is very good, 10% said good, 15% said acceptable, and 5% said no comments.

The main advantages:
1. The Indian dill or sowa is known for its medicinal properties like carminative, antipyretic and antihelmintic, in addition to being an antiflatulent.
2. The soup mix has good anti-oxidant properties with its Phenol content mg/g 4.5; and Reducing Power of the source (soup mix) U/g 870;
3. Soups play an important role as an appetizer in diet.
4. Being a dry soup mix it has a better shelf life.
5. It can be easily reconstituted by mixing in 1:10-12 ratio of soup powder:cold water. The mixture is stirred and brought to boil before serving.
6. The product prepared by the present invention has excellent sensory qualities in terms of color, consistency, flavor and overall quality.
7. The product prepared by the present invention and packed in metallized PET/Poly laminate pouches has good storage stability beyond 8 months at room temperature without affecting the sensory characteristics.

We claim:

1. A process for the preparation of instant soup mix from Indian dill (Anethum sowa), said process comprising the steps:
i) cutting the cleaned Indian dill leaves into shreds of 4-5 cm long;
ii) soaking the shreds of step (i) in a solution containing 0.5 to 1.0% sodium bi carbonate for a period of 20 to 40 minutes;
iii) drying the soaked shreds of step (ii) using hot air at a temperature in the range of 40°-50° C.;
iv) powdering the dried shreds of step (iii) and passing through sieve with a pore size of about 400 to 600 μm.
v) powdering the drum dried, cabinet dried and sun dried potato cubes, and dried onion shreds and passing through sieve with a pore size of about 500 μm.
vi) mixing skim milk powder:Corn flour:Potato flour:wheat flour:malto dextrin:fat:dill powder:salt:sugar:onion:pepper with a ratio in the range of 10-20:12-15:10-12:10-14:10-14:3-8:3-6:3-5:3-7:2-4:1-2.5 (w/w) respectively to obtain soup mix, and
vii) obtaining the instant soup mixture by drying the soup mix of step (vi) till the moisture content of the said becomes 3 to 5%.

2. A process as claimed in claim 1, wherein in step (ii) the ratio of shreds and solution is 1:2.

3. A process as claimed in claim 1, wherein in step (v) the potatoes and onions are dried using drying techniques selected from a group comprising drum drying, cabinet drying and sun drying.

4. A process as claimed in claim 3, wherein the drum drying of potato is performed by following steps:
(i) dicing the potatoes into cubes;
(ii) cooking potatoes of step (a) at 70 to 75° C. in an autoclave for about 15 to 20 minutes followed by cooling at 12 to 17° C. for about 15 to 20 minutes;
(iii) cooking the cooled potatoes of step (ii) at a temperature in the range of 75 to 85° C. for about 15 to 20 minutes;
(iv) mashing the cooked potatoes of step (iii) in a mixture;
(v) adding potassium metabisulphite in the range of 1500 to 2500 mg/kg, whey protein concentrate in the range of 0.02% to 0.09% and monosodium glutamate in the range of 0.05 to 0.1% to the potato mash, and
(vi) drying the potato mash of step (v) and ground into powder followed by passing through a sieve with a pore size in the range of 400 to 600 μm to obtain the potato flour.

5. A process as claimed in claim 4, wherein the cabinet drying of potato is performed by following steps:
(i) dicing the potatoes into cubes;
(ii) autoclaving the potatoes of step (i) for a period of about 3 to 8 minutes to inactivate the enzyme followed by cooling the same;
(iii) adding potassium metabisulphite to the potatoes of step (ii) in the range of 1500 to 2500 mg/kg for a period of 10 to 30 minutes;
(iv) drying the cooled potato of step (iii) at a temperature in the range of 60-70° C. for about 6 to 8 hours, and
(v) grinding the dried potato of step (iv) into powder followed by passing through a sieve with a pore size in the range of 400 to 600 μm to obtain the potato flour.

6. A process as claimed in claim 4, wherein the drying and grinding of onion is performed by following steps:
(i) slicing the peeled onion;
(ii) drying the sliced onion of step (i) in hot air at a temperature in the range of 55 to 65° C. to obtain the dehydrated onion shreds, and
(iii) grinding the dehydrated onion shreds of step (ii) and passing through a sieve with a pore size in the range of 400 to 600 μm to obtain the onion powder.

7. A process as claimed in claim 1, wherein in step (vi) the peak viscosity, hot paste viscosity and cold paste viscosity of soup mix using drum dried potato flour are 127, 107 and 186 cps respectively.

8. A process as claimed in claim 1, wherein in step (vi) the peak viscosity, hot paste viscosity and cold paste viscosity of soup mix using cabinet dried potato flour in the soup mix are 145, 126 and 288 cps respectively.

9. A process as claimed in claim 1, wherein in step (vi) the peak viscosity, hot paste viscosity and cold paste viscosity of soup mix using native potato flour in the soup mix are 182, 167 and 291 cps respectively.

10. A process as claimed in claim 1, wherein in step (vi) the peak viscosity, hot paste viscosity and cold paste viscosity of soup mix using cabinet dried potato flour in place of corn flour and wheat flour in the soup mix are 133, 130 and 208 cps respectively.

11. A process as claimed in claim 1, wherein in step (vi) the soup mix is packed in metallsied polyester/polyethylene laminate pouches having a thickness of 150 to 250 gauge, has a shelf life up to 8 months in 65% relative humidity at room temperature.

12. A process as claimed in claim 1, wherein in step (vii) the soup mix when reconstituted in cold water (soup mix: water:1:10-12), stirred and brought to boil has an excellent color, taste, flavor and consistency and over all quality.

13. A process as claimed in claim 1, wherein the instant soup mix is free flowing with a moisture content in the range of 3 to 5%, critical moisture content in the range of 9 to 13%, fat in the range of 8 to 9.5%, free fatty acids mg/g about 3.36, peroxide value/g: nil, hunter color values as L, a, b, L: 73.0, a: −4.137, b: 16.13 and total plate counts is about 18750/g and yeast and moulds is not present.

14. An instant soup mix as claimed in the process of claim 1.

15. An instant soup mix as claimed in claim 15, wherein the soup is free flowing with a moisture content in the range of 3 to 5%, critical moisture content in the range of 9 to 13%, fat in the range of 8 to 9.5%, free fatty acids mg/g about 3.36, peroxide value/g: nil, hunter color values as L, a, b, L: 73.0, a: −4.137, b: 16.13 and total plate counts is about 18750/g and yeast and moulds is not present.
